(19) United States
(12) Patent Application Publication
(10) Pub. No.: US 2009/0030112 A1
(43) Pub. Date: Jan. 29, 2009

(54) BIODEGRADABLE POLYMERIC COMPOSITION AND METHOD FOR PRODUCING A BIODEGRADABLE POLYMERIC COMPOSITION

(75) Inventors: Jefter Fernandes Nascimento, Sao Paulo City (BR); Wagner Mauricio Pachekoski, Sao Carlos (BR); Dawson Buim Arena, Sao Paulo City (BR); Ana Cristina Coelho, Sao Joao Da Boa Vista (BR)

Correspondence Address: DARBY & DARBY P.C., P.O. BOX 770, Church Street Station, New York, NY, 10008-0770, US

(73) Assignees: PHB INDUSTRIAL S.A., Serrana - SP (BR); KEHL INDUSTRIA E COMERCIO LTDA, San Carlos - SP (BR)

(21) Appl. No.: 12/280,400

(22) PCT Filed: Feb. 23, 2007
(86) PCT No.: PCT/BR07/00047

§ 371 Date: Oct. 20, 2008

(30) Foreign Application Priority Data
Feb. 24, 2006 (BR) PI0600783-0

(51) Int. Cl. C08L 67/04; C08K 5/00; C08K 3/22

(52) U.S. Cl. 523/124

(57) ABSTRACT

Biodegradable polymeric composition and method for producing a biodegradable polymeric composition, comprising poly(hydroxybutyrate) or copolymers thereof, a plasticizer obtained from a renewable source, a nucleant additive, a flow aid additive, and a thermal stabilizer additive. The process of obtention comprises the steps of mixing to a load of PHB or PHBV in powder, from about 2% to 30% of a plasticizer based on vegetable oils of natural origin and fatty acids of animal and vegetable origin, distilled and hydrogenated; mixing to the biopolymer already containing the plasticizer a thermal stabilizer additive, a nucleant additive; and a flow aid additive; and extruding the composition obtained in the previous step to promote, in the melt state, the incorporation of the additives in the matrix of PHB or PHBV and its subsequent granulation.

### FIELD OF THE INVENTION

The present invention refers to a biodegradable polymeric composition modified with plasticizers obtained from renewable sources and with other additives capable to improve the physical, chemical and mechanical properties of the polymeric articles produced from said composition to be used for manufacturing biodegradable articles useful in several applications.

### PRIOR ART

In the last years, the increasing utilization of biodegradable polymers has aroused a great worldwide industrial interest regarding the utilization of renewable raw materials and energy sources through processes that are not aggressive to the environment. The term biodegradable polymers refers to a degradable polymer, in which the degradation results from the action of microorganisms of natural occurrence, such as bacteria, fungi and algae.

The polymers and copolymers obtained from the poly (hydroxyalkanoates) (PHAs) can be produced through several microorganisms, in response to a limitation of nutrients. The great development of the natural sciences in the last two decades, particularly in biotechnology, has allowed the use of most different natural or genetically modified organisms in the commercial production of PHAs.

Since then, the applications of these biodegradable biopolymers has aroused the worldwide industrial interest, involving the use as disposable materials, such as packages, cosmetic and toxic agrochemical recipients, and medical and pharmaceutical applications.

However, the use and acceptance of PHAs still present some limitations that prevent their application to be broadly spread, as a function of their physical and chemical characteristics which, many times, do not reach determined properties that are required so that the processed end product is useful in the manufacture of articles in all of the fields mentioned above, without incurring in environmental and processing damages.

Within the class of the biodegradable polymers (PHAs), the structures containing ester functional groups are of remarkable interest, mainly due to their usual biodegradability and versatility in physical, chemical and biological properties. The poly (hydroxyalkanoates) (PHAs), polyesters derived from carboxylic acids, can be synthesized by biological fermentation and chemically.

The poly (hydroxybutyrate) (PHB) is the main member of the polyhydroxyalkanoate class. Its great importance is justified by the combination of three important factors: the fact of being 100% biodegradable, it is water-resistant and it is a thermoplastic polymer, which can be utilized in the same applications as the conventional polymers. The structural formulas of the 3-hydroxybutyric acid (a) and of the poly (3-hydroxybutyric acid)(b), are illustrated below.

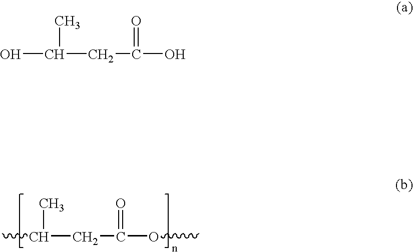

The production process of the poly (hydroxybutyrate) basically consists of two steps:
fermentative step: in which the microorganisms metabolize the sugar available in the environment and accumulate the PHB in the interior of the cell as reserve source;
extraction step: in which the polymer accumulated in the interior of the cell of the microorganism is extracted and purified until a solid and dry end products is obtained.

Developments about the subject matter have allowed the use of sugar and/or molasse as a basic component of the fermentative medium, the fusel oil (organic solvent—byproduct of alcohol manufacture) as extraction system of the polymer synthesized by the microorganisms, as well as the use of the excess sugarcane bagasse to produce energy (vapor generation) for these processes. This project permitted a perfect vertical integration with the maximum utilization of the byproducts generated in the sugar and alcohol manufacture, providing processes that utilize the so-called clean and ecologically correct technologies.

Through a process of production similar to that of the PHB, it is possible to produce a semicrystalline bacterial copolymer of poly-(3-hydroxybutyrate) with random segments of poly-(3-hydroxyvalerate), known as PHBV. The main difference between both processes is based on the addition of the proprionic acid in the fermentative medium. The quantity of proprionic acid in the bacteria feeding is responsible for the control of poly (hydroxyvalerate)—PHV concentration in the copolymer, enabling variation of degradation time (which can be from some weeks up to several years) and certain physical properties (molar mass, degree of crystallinity, surface area, for example). The composition of the copolymer further influences the fusion point (which can range from 120 to 180° C.), and characteristics of ductility and flexibility (which are improved with the increase of PHV concentration). The basic structure of the PHBV is represented through the formula:

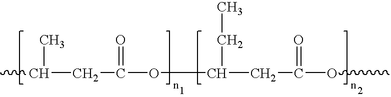

According to some studies, the PHB shows a behavior with some ductility and maximum elongation of 15%, tension elastic modulus of 1.4 GPa and notched IZOD impact strength of 50 J/m soon after the injection of the specimens. Such properties modify as time goes by and stabilize in about one month, with the elongation reducing from 15% to 5% after 15 days of storage, reflecting the fragility of the material. The tension elastic modulus increases from 1.4 GPa to 3 GPa, while the impact strength reduces from 50 J/m to 25 J/m after the same period of storage. Table 1 presents some properties of the PHB compared to the Isostatic Polypropylene.

TABLE 1
Comparison of the PHB and the PP properties.

| Properties | PHB | PP |
|---|---|---|
| Degree of crystallinity (%) | 80 | 70 |
| Average Molar mass (g/mol) | 4 × 10⁵ | 2 × 10⁵ |
| Fusion Temperature (° C.) | 175 | 176 |
| Glass Transition Temperature (° C.) | −5 | −10 |
| Density (g/cm³) | 1.2 | 0.905 |
| Modulus of Flexibility (GPa) | 1.4-3.5 | 1.7 |
| Tensile strength (MPa) | 15-40 | 38 |
| Elongation at break (%) | 4-10 | 400 |
| UV Resistance | good | poor |
| Solvent Resistance | poor | good |

The degradation rates of articles made of PHB or its Poly ( 3-hydroxybutyric-co-hydroxyvaleric acid)—PHBV copolymers, under several environmental conditions, are of great relevance for the user of these articles. The reason that makes them acceptable as potential biodegradable substitutes for the synthetic polymers is their complete biodegradability in aerobic and anaerobic environments to produce CO₂ /H₂O/biomass and CO₂/H₂O/CH₄/biomass, respectively, through natural biological mineralization. This biodegradation usually occurs via surface attack by bacteria, fungi and algae. The actual degradation time of the biodegradable polymers and, therefore, of the PHB and PHBV, will depend upon the surrounding environment, as well as upon the thickness of the articles.

Many polymeric compositions has been developed to improve the final properties of the product, to enable the variation of the degradation time (which can be from some weeks to several years) and certain physical properties (molar mass, degree of crystallinity, surface area, for example). The copolymer composition also influences the fusion point (which can range from 120 to 180° C.), and the characteristics of ductility and flexibility (which are improved with the increase of PHV concentration).

Despite several efforts carried out in this area, the production of polymeric film with adequate properties for several applications from PHAs, PHB and PHBV has been very difficult due to the mechanical characteristics of these biopolymers, which are frequently unacceptable, since their fragility, quick aging and fusion deficiency, as well as its production process are unavailable and expensive, as described in European patent application EP 1 593 705 A1. The product obtained through the solution EP 1 593 705 requires the utilization of a continuous process for producing said film, further including one or more layers of non-PHAs polymers, in order to improve desired properties, besides facilitating its processing condition.

Although some known prior art solutions have accomplished good results with the known biodegradable compositions, deficiencies still exist regarding thermal degradation, high crystallinity, low crystallization rate, delay of hardening, and the like, since the improvement rates that were reached considering toughness, rigidity, fluid and coloring index, are still insignificant.

However, the major limitation of the documents cited above is the extremely low versatility of their formulations, which make them unsuitable for application in other types of usual polymer forming processes, such as for example, injection, thermoforming and calendering. Products based on the prior art compositions, once they do not present a group of efficient additives, require longer injection cycles to guarantee the complete hardening of the end article for its extraction from the mould. This characteristic reduces the productivity of pieces per hour, raising the price of the end product and increasing the energy consumption. The finished piece also presents a high degree of darkening, due to thermal degradation and unsuitable mechanical properties, such as fragility and low mechanical strength.

Moreover, said known compositions are further inadequate for the blowing and thermoforming processes. These processes require a certain melt strength for construction of the piece and, due to the high fluidity found in these formulations, this strength is extremely low or non-existent.

The polymeric compositions provided by the present invention have the object to improve the versatility of the articles, allowing them to be used in the production of films or in several techniques of polymer processing, such as extrusion, injection, blowing and thermoforming without impairing the processing or the quality of the end product.

### SUMMARY OF THE INVENTION

From the above, it is a generic object of the present invention to provide a biodegradable polymeric composition comprising polymers and copolymers obtained from polyhydroxyalkanoates, and which presents improved physical, chemical and mechanical properties, so as to enlarge its application field and to permit its production by simple and fast processes/methods, which can be economically viable in large scale production.

It is a further object of the present invention to provide a method for producing biodegradable polymeric composition as defined above.

### DETAILED DESCRIPTION OF THE INVENTION

### Additives:

As already mentioned, the invention refers to a polymeric composition obtained from biodegradable polymers and copolymers which are additivated according to specific procedures capable of substantially improving their properties, reduce at maximum the adverse characteristics and also develop new properties which can be advantageous to the product obtained therefrom. For the poly (hydroxybutyrate), the necessity of additives is evidenced due to its easy thermal degradation, high crystallinity and low crystallization rate.

The plasticizers pertain to the class of additives of major importance in the modification of the PHB, since they are responsible for the more significant changes in this polymer. These products are also utilized in a greater quantity than any other additive, significantly contributing to the end product cost. In general, the plasticizer stays among the polymer chains, hampering its crystallization. In the specific case of the PHB, this lower crystallization rate contributes to reduce the material processing temperature, reducing its thermal degradation. The lower crystallinity contributes also to a higher flexibility of the chains, making the poly (hydroxybutyrate) less rigid and fragile. In general, plasticizers present maximum concentration useful in the PHB. Concentrations over this limit result in the exudation of the excess product, impairing the surface finishing of the silk screen or Corona type.

For reducing the degradation caused by the severity of the aggressive agents (shearing, temperature and 5 oxygen), in the processing of polymeric compositions from the PHB, the addition of complete systems of thermal stabilization is promoted. These packages of stabilizers can present several components and are generally developed by companies specialized in polymer additivation, such as Ciba and Clariant.

As a complementary cooperative function, aiming at reducing shearing and consequently the degradation of the polymer, it is possible to use secondary co-stabilizers, of the processing aid type (internal lubricant, external lubricant and flow modifiers). These materials are constituted of mixtures of metallic soaps of alkaline, earth alkaline and transition metals, organic phosphonates and fatty amides.

For the thermodynamic and kinetic control of the crystallization process (nucleation and growth) of the PHB, of its copolymers and polymeric compositions, the nucleant content can range between about 0.01% and 2% in percentage of mass, in a combined form with the cooling gradient imposed to the polymeric material during its final processing stage, according to the desired crystalline morphology and degree of crystallinity.

### Preparation of Plasticizers of Natural Origin

The plasticizers based on vegetable oils and fatty acids of animal and vegetable origin that are distilled and hydrogenated, were obtained through two preparation processes:
Esterification of fatty acids of animal or vegetable origin with alcohols of linear and branched carbonic chain with a quantity of carbons ranging from 1 to 10. catalyzed by strong acids.
Transesterification of vegetable oils distilled and hydrogenated with alcohols of carbonic chain ranging from one to ten carbons, linear or branched, with basic catalysis.

The vegetable oils utilized for producing the plasticizers were: soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives. These oils present the following structural formula:

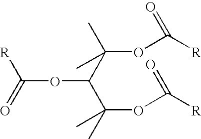

where R ranges from C6 to C24, which can be saturated, monounsaturated and polyunsaturated.

The vegetable and animals fatty acids utilized for the essays were:
saturated: caproic acid, caprilic acid, capric acid, lauric acid, miristic acid, palmitic acid, margaric acid, estearic acid, behenic acid, aracdic acid, lignoceric acid
Monosaturated: palmitoleic acid, oleic acid, gadoleic acid, euricic acid
Polyunsaturated: linoleic acid, aracdonic acid, linolenic acid

These fatty acids can present the following structural formula:

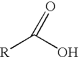

where R can range from C6 to C24, which can be saturated, monounsaturated and polyunsaturated.

The alcohols utilized for the synthesis were selected among alcohols that have from 1 to 10 carbons and linear and branched chains obtained from renewable sources.

R—OH

where R can range from C1 to C10. presenting linear or branched chains.

For the products obtained from esterification reactions, such as sulfuric acid, phosphoric acid, methanesulfonic acid, were utilized acid catalysts. In the transesterification reactions, basic catalysts were used with NaOH, KOH, and other bases.

The plasticizers obtained from the processes and raw materials indicated above have the following formula:

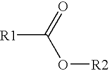

where R1 can range from C6 to C24, which can be saturated, monounsaturated and polyunsaturated and R2 can range from C1 to C10. presenting linear or branched chain.

The plasticizer is provided in the polymeric composition in a proportion that ranges between about 2% and about 30%, preferably between 2% and 15% and, more preferably, between 5% and 10%.

### Preparation of the Flow aid

The flow aid was prepared from the mixture of about 40% of a metallic soap, about 20% of a organic phosphonate and about 40% of a fatty amide, at ambient temperature and utilizing, if necessary, alcohol of short chain from C1 to C5 of linear or branched chain as co-solvent.

The waxes of fatty amides utilized were primary, secondary amides, bis amides (saturated, unsaturated or aromatic) such as, for example: oleamide, stearamide, linoleamide, palmitamide, apramide, erucamide, behenamide, ethylenebislauramide, ethylenebisstearamide, ethylenebisoleamide, ethylenebispalmitamide, ethylenebiscapramide, ethylene N palmitamide N stearamide, methylenebisstearamide, hexamethylenebisoleamide, hexamethylenebisstearamide,N,N-dioleiladipamide, N,N dioleilsebacamide, m-xylenebisstearamide, N,N distearylisophtalamide, and the like.

The metallic soaps utilized in the essays were: calcium stearate, zinc stearate, magnesium stearate, aluminum stearate, barium stearate, calcium laurate, zinc laurate, magnesium laurate, barium laurate, aluminum laurate and fatty soaps saturated from other alkaline metals, earth alkalines and also transition metals.

The disphosphonic acids utilized were the 1-hydroxyethylidene-1,1 disphosphonic acid (HEDP), 1-hydroxypropylidene-1,1 disphosphonic acid (HPDP), 1-hydroxybutylidene-1,1 disphosphonic acid (HBDP) and 1-hydroxycyclohexylidene-1,1 disphosphonic acid (HCEDP).

The flow aid is provided in the biodegradable polymeric composition in a proportion that ranges between about 0.01% and about 2%, preferably between 0.05% and 1% and, more preferably, between 0.1% and 0.5%.

### Thermal Stabilizers and Nucleants

Tests were carried out with the following stabilization packages provided by Clariant: Hostanox 101, Hostanox 102, Hostanox 104, Hostanox 105, Hostanox O10, Hostanox O16 and Sandostab QB 55 FF. Tests were carried out with the following thermal stabilizers provided by Ciba: Irganox E, Irganox 1425, Irganox 1010, Irganox 1098, Irganox 3790 and Irganox L 115. These products were tested separately or in mixtures, being utilized in a concentration range varying between 0.01% and 2%, preferably 0.05% and 1% and, more preferably, between 0.1% and 0.5%.

The following chemical products were tested as nucleants: sorbitol, sodium benzoate, saccharine, boron nitride, micronized silica and ammonium chloride. The nucleants utilized were developed by companies specialized in polymer additivation: HPN and Millad 3988 of Milliken Chemical. All of these products were tested separately, a concentration range varying between 0.01% and 2%, preferably between 0.05% and 1% and, more preferably, 0.1% and 0.05%.

### Methodology for Producing the Polymeric Compounds and Properties Obtained

Mixture of the components:

The natural plasticizer was incorporated to the poly(hydroxybutyrate) or poly(hydroxybutyrate-valerate) in powder in a “Henschel” mixer or similar equipment, in ambient temperature, over the time of 15 minutes. The proportion of plasticizer varied from 2% to 30%, presenting, however, better results for the values between 5% and 10%.

After incorporating of the plasticizer, there were mixed to the PHB or PHBV in powder the other additives: thermal stabilizer, flow aid and nucleant. These additives were mixed to the plasticized PHB or PHBV in a “Henschel” mixer or similar equipment, in ambient temperature, over a time of 5 minutes and in a range between 0.01% and 2%, presenting, however, better results for concentrations between 0.1% and 0.5%.

### Extrusion:

Twin Screw Extruder Co-Rotating Intermeshing
Brand: Werner & Pfleiderer ZSK-30 (30 mm) or the like
Gravimetric Feeders/Dosage Systems of high precision

The extrusion process was responsible for the incorporation of the natural plasticizer into the matrix of PHB or PHBV in the melt state, as well as for its granulation. A modular screw profile with conveying elements (left/right handed) was utilized, controlling the pressure field, and kneading elements (kneading blocks), to control the fusion and the mixture. This group of elements was a primordial factor for achieving a suitable morphological control of the structure and a good dispersion of the particles in the polymeric matrix.

Table 2 presents the extrusion processing conditions for the PHB or PHBV /Additives polymeric compositions.

TABLE 2
Extrusion processing conditions of the PHB or
PHBV/Additives polymeric compositions.

| | Temperature (° C.) | | | | | | | Speed |
|---|---|---|---|---|---|---|---|---|
| Sample | C1 | C2 | C3 | C4 | C5 | Matrix | Melt | (rpm) |
| PHB | 115 | 135 | 155 | 145 | 130 | 160 | 170 | 150 |
| PHBV | 105 | 120 | 125 | 130 | 130 | 150 | 160 | 150 |

### Injection Moulding:

Arburg 270V Injection Molding Machine—30 tons, operated by computer system.
Mould for producing specimens for the essays of tensile strength regarding norm ASTM 638 and notched IZOD impact strength regarding norm ASTM 256.

Injection is the process for producing end products more utilized in the plastic transformation industry, providing products of small dimension, from mugs to automobilistic industry articles, as truck bumpers. Through this process specimens will be produced, which are necessary to evaluate the mechanical properties of the examples presented. Table 3 presents the injection conditions.

TABLE 3
Injection conditions of the PHB or PHBV/
Additives polymeric compositions.

| Temperature | |
|---|---|
| profile (° C.) | Pressure Profile/Times |
| Zone 1: 152 | Pressure (bar): 400 |
| Zone 2: 156 | Pressurization (bar): 380 |
| Zone 3: 172 | Flow rate (cm³/s): 20 |
| Zone 4: 172 | Holding (bar): 300 |
| Zone 5: 170 | Holding Time (s): 12 |
| Mould (° C.): 35 | Counter pressure (bar): 40 |
| Cooling Time (s): 32 | Dosing speed (mm/min): 12 |

### Description of the Formulations and Properties of the Compounds:

Poly(hydroxybutyrate): The PHB was extruded, injected and had its mechanical properties tested without any 5 type of additive being mixed into its composition. During the processing, the product delayed to become rigid, regardless the temperature, impairing its granulation and extraction from the mould. Observing its physical properties, a relatively high fluid index of the extruded material was found significantly high to impair the injection of the pieces using said product, as well as mechanical properties referring to a rigid and fragile material. Table 4 presents the properties of the poly(hydroxybutyrate).

PHBV presents both processing properties and mechanical properties similar to those of the PHB, and the examples of additives are comparable to both types of biopolymers.

Several compositions of polymeric mixtures were tested from biodegradable polymers, plus plasticizers obtained from renewable sources, plus additives of the nucleant type, thermal stabilizer and flow aid, with several examples being presented below.

Tests with Plasticizers

Six different plasticizers of natural origin were comparatively tested, in the same proportion and with the same quantity of additives. Among the plasticizers tested, there were products, such as Logosplast 0902 and Logosplast 5343, commercialized by Logos Quimica. (examples 1 and 2, respectively), as well as the epoxided soybean oil, epoxided castor oil, and acetyl butyl citrate (examples 3, 4 e 5, respectively) disclosed in documents WO 94/28061, U.S. Pat. No. 6,774,158B2, and U.S. Pat. No. 6,127,512, as products that can efficiently plasticize the poly(hydroxybutyrate) and copolymers thereof. The examples are presented below, with their properties presented in table 4.

For all the examples presented, it was found a more stable product processing, as well as a faster hardening, facilitating its granulation and extraction from the mould. All the materials presented a lower fluid index, indicating a lower thermal degradation of the end product. The mechanical properties were also improved and both the toughness and flexibility of the poly(hydroxybutyrate) were obtained. Table 4 presents the comparative results. Films of about 50 micra of thickness of poly(hydroxybutyrate) and of the examples presented in Table 4 were buried in a biologically active soil, with the purpose of evaluating the biodegradability of these materials. As a result, it was found that all of the films disappeared completely in a period of 60 days, confirming the biodegradability thereof.

Comparatively, examples 1 and 2 present a higher plasticizing effect on both PHB and PHBV in relation to the examples 3, 4 and 5. This effect is mainly demonstrated by the significant increase in the mechanical properties of impact strength and elongation at break, indicating an increase in the toughness of these polymeric compounds. Examples I and 2 showed an even better processability in relation to examples 3, 4 and 5, with higher stability of the extruded product and possibility of shorter injection cycles.

### Example 1

Tests of mixtures of poly (hydroxybutyrate) with 6% of product Logosplast 0902 acting as a plasticizer, 0.1% boron nitride acting as a nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

### Example 2

Tests of mixtures of poly (hydroxybutyrate) with 6% of product Logosplast 5343 acting as plasticizer, 0.1% of boron nitride acting as nucleant, 0.1% of a mixture (50/50) of the thermal stabilizers Irganox L115 and Irganox 1425 and 0.1% of a mixture (40/40/20) of ethylenebisteramide (EBS), calcium/zinc stearate and HPDP as flow aid.

### Example 3

Tests of mixtures of poly (hydroxybutyrate) with 6% of epoxided castor oil acting as plasticizer, 0.1% of boron nitride acting as nucleant, 0.1% of a mixture (50/50) of the thermal stabilizers Irganox L115 and Irganox 1425 and 0.1% of a mixture (40/40/20) of ethylenebisteramide (EBS), calcium/zinc stearate and HPDP as flow aid.

### Example 4

Tests of mixtures of poly (hydroxybutyrate) with 6% of acethyl butyl citrate (ATC) acting as plasticizer, 0.1% of boron nitride acting as nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

### Example 5

Tests of mixtures of poly (hydroxybutyrate) with 6% of epoxided soybean oil acting as plasticizer, 0.1% of boron nitride acting as nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

TABLE 4
Properties of the PHB or PHBV/Additives polymeric
compositions.

| PROPERTY | PHB | Example 1 | Example 2 | Example 3 | Example 4 | Example 5 |
|---|---|---|---|---|---|---|
| Density | 1.2 | 1.2 | 1.2 | 1.2 | 1.2 | 1.2 |
| Fluid Index | 16 | 10 | 11 | 12 | 12 | 11 |
| (g/10 min) | | | | | | |
| Tensile Ultimate | 25 | 40 | 38 | 28 | 30 | 28 |
| Strength (MPa) | | | | | | |
| Tensile Elongation | 5 | 12 | 10 | 8 | 8 | 6 |
| at Break (%) | | | | | | |
| Tension Elastic | 2.1 | 1.8 | 1.9 | 2.0 | 2.0 | 2.1 |
| Modulus (GPa) | | | | | | |
| Notched IZOD | 25 | 40 | 37 | 30 | 33 | 31 |
| Impact Strength | | | | | | |
| (J/m) | | | | | | |

Tests with Nucleants.

Four different nucleants were comparatively tested, in the same proportion and with the same quantity of other additives. The nucleants tested were boron nitride, ammonium chloride, micronized silica and product HPN of Milliken Chemical (examples 6, 7, 8 and 9, respectively). Examples are presented below, with their properties presented in Table 5.

For all the examples presented a more stable product processing has been found, as well as a faster hardening, facilitating its granulation and extraction from the mould. All the materials presented a lower fluid index, indicating a lower thermal degradation of the end product. The mechanical properties were also improved, obtaining toughness from the poly(hydroxybutyrate) and poly(hydroxybutyrate-valerate). Films of about 50 micra of thickness were buried in a biologically active soil, with the purpose of evaluating the biodegradability of these materials. As a result, it was found that all of the films disappeared completely in a period of 60 days, confirming the biodegradability thereof.

Comparatively, the boron nitride and the product HPN of Milliken Chemical (examples 6 and 9, respectively) presented the best results, with products of higher toughness without a significant loss of rigidity. This product characteristic is attributed to the global action resulting from using a nucleant jointly with other additives, such as plasticizer, flow aid and thermal stabilizer. Documents GB 1 139 258, EP 0 291 024, PA 211 258 (Tosoh), U.S. Pat. No. 6,774,158B2 and U.S. Pat. No. 6,127,512 suggest products in which the nucleant is utilized separately or only jointly with a plasticizer (as seen in examples 10 and 11, of table 5), which products did not present an increase in toughness without a significant increase in the rigidity and fragility.

Boron nitride and micronized silica further present the disadvantage of dyeing the end product, which is a characteristic pointed out as disadvantageous in patent U.S. Pat. No. 6,774,158 B2, as it renders opaque films. The products in which the ammonium chloride and HPN are used as nucleants do not present dyeing.

### Example 6

Tests of mixtures of poly (hydroxybutyrate) with 6% of product Logosplast 0902 acting as plasticizer, 0.1% of boron nitride acting as nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

### Example 7

Tests of mixtures of poly (hydroxybutyrate) with 6% of product Logosplast 0902 acting as plasticizer, 0.1% of ammonium chloride acting as nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

### Example 8

Tests of mixtures of poly (hydroxybutyrate) with 6% of 6% of the product Logosplast 0902 acting as plasticizer, 0.1% of micronized silica acting as nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

### Example 9

Tests of mixtures of poly (hydroxybutyrate) with 6% de 6% of product Logosplast 0902 acting as plasticizer, 0.1% of HPN of Milliken Chemical acting as nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

### Example 10

Tests of mixtures of poly (hydroxybutyrate) with 6% of product Logosplast 0902 acting as plasticizer, 0.1% of boron nitride acting as nucleant.

### Example 11

Tests of mixtures of poly (hydroxybutyrate) with 0.1% of boron nitride acting as nucleant.

TABLE 5
Properties of the PHB or PHBV/Additives
polymeric compositions.

| PROPERTY | PHB | Ex. 6 | Ex. 7 | Ex. 8 | Ex. 9 | Ex. 10 | Ex. 11 |
|---|---|---|---|---|---|---|---|
| Density | 1.2 | 1.2 | 1.2 | 1.2 | 1.2 | 1.2 | 1.2 |
| Fluid Index | 16 | 10 | 11 | 12 | 10 | 11 | 13 |
| (g/10 min) | | | | | | | |
| Tensile Ultimate | 25 | 40 | 28 | 30 | 38 | 28 | 28 |
| Strength (MPa) | | | | | | | |
| Tensile | 5 | 12 | 8 | 8 | 11 | 6 | 4 |
| Elongation | | | | | | | |
| at Break (%) | | | | | | | |
| Tension Elastic | 2.1 | 1.8 | 2.2 | 2.1 | 1.9 | 2.1 | 2.1 |
| Modulus (GPa) | | | | | | | |
| Notched IZOD | 25 | 40 | 35 | 33 | 42 | 31 | 28 |
| Impact Strength | | | | | | | |
| (J/m) | | | | | | | |

Tests with Thermal Stabilizers

For the thermal stabilization tests, it was initially evaluated the color change (degree of darkening) and the increase of the fluid index of the poly(hydroxybutyrate) after being processing in a extruder, with the addition of a thermal stabilizer. Thermal stabilizers Irganox 1425, Irganox L115 and Irganox E of Ciba, stabilizers Hostanox 016 of Clariant were tested. Mixture (40/40/20) of ethylenebisteramide (EBS), calcium/zinc stearate and HPDP cited in documents U.S. Pat. No. 6,774,158B2 and U.S. Pat. No. 6,127,512 was also tested as a highly efficient stabilizer for the PHB. The examples are cited below, while the evaluated properties are presented in Table 6.

As a result, two distinct behaviors were observed for the thermal stabilizers. Stabilizers Irganox 1425 and Irganox E (examples 13 and 14) presented significant reduction in the fluid index, characterizing an increase in the thermal stability, but they were not efficient as darkening inhibitors. Stabilizers Irganox L 115 and Hostanox 016 had no influence in the fluid index of PHB, but significantly avoided the darkening of the extruded.

Mixture (40/40/20) of ethylenebisteramide (EBS), calcium/zinc stearate and HPDP, cited in documents U.S. Pat. No. 6,774,158 and U.S. Pat. No. 6,127,512 as a highly efficient stabilizer for the PHB, did not show satisfactory results as a thermal stabilizer.

### Example 12

Tests of mixtures of poly (hydroxybutyrate), with 0.1% of Irganox L 115 acting as thermal stabilizer.

### Example 13

Tests of mixtures of poly (hydroxybutyrate), with 0.1% of Irganox 1425 acting as thermal stabilizer.

### Example 14

Tests of mixtures of poly (hydroxybutyrate), with 0.1% of Irganox E acting as thermal stabilizer.

### Example 15

Tests of mixtures of poly (hydroxybutyrate), with 0.1% of Hostanox 016 acting as thermal stabilizer.

### Example 16

Tests of mixtures of poly (hydroxybutyrate), with 0.1% of mixture (40/40/20) of ethylenebisteramide (EBS), calcium/zinc stearate and HPDP acting as thermal stabilizer.

TABLE 6
Properties of the PHB or PHBV/Additives
polymeric compositions.

| PROP- | | | | | | |
|---|---|---|---|---|---|---|
| ERTY | PHB | Ex. 12 | Ex. 13 | Ex. 14 | Ex. 15 | Ex. 16 |
| Fluid | 16 | 15 | 10 | 12 | 16 | 16 |
| Index | | | | | | |
| (g/10 min) | | | | | | |
| Color | dark | Yellowish- | yellow | yellow | light | dark |
| | yellow | white | | | yellow | yellow |

Mixtures of stabilizers were also tested, in order to obtain a product with lower fluid index and lower degree of darkening. The examples are cited below and their properties are presented in Table 7.

As a result, it was found that both mixtures of thermal stabilizers were effective in the PHB stabilization, reducing its fluid index and degree of darkening.

### Example 17

Tests of mixtures of poly (hydroxybutyrate) with 0.1% of Irganox L 115 and 0.1% of Irganox 1425 acting as thermal stabilizers.

### Example 18

Tests of mixtures of poly (hydroxybutyrate) with 0.1% of Hostanox 016 and 0.1% of Irganox E acting as thermal stabilizers.

TABLE 7
Properties of the PHB or PHBV/Additives
polymeric compositions.

| PROPERTY | PHB | EXAMPLE 17 | EXAMPLE 18 |
|---|---|---|---|
| Fluid Index | 16 | 9 | 12 |
| (g/10 min) | | | |
| Color | Dark brown | yellow | yellow |

Mixtures of the thermal stabilizers were further tested jointly with the other additives (plasticizer, nucleant and flow aid). The examples are cited below and their properties are presented in Table 8.

For all the examples presented it was found a more stable product processing, as well as a faster hardening, facilitating its granulation and extraction from the mould. All of the materials presented a lower fluid index, indicating a lower thermal degradation of the end product. The mechanical properties were also improved, with both toughness and flexibility of the poly(hydroxybutyrate) and poly(hydroxybutyrate-valerate) being achieved. Films of about 50 micra of thickness were buried in a biologically active soil, with the purpose of evaluating the biodegradability of these materials. As a result, it was found that all of the films disappeared completely in a period of 60 days, confirming the biodegradability thereof.

### Example 19

Tests of mixtures of poly (hydroxybutyrate) with 6% of product Logosplast 0902 acting as plasticizer, 0.1% of boron nitride acting as nucleant, 0.1% of a mixture (50/50) of thermal stabilizers Irganox L115 and Irganox 1425 and 0.1% of a mixture (40/40/20) of ethylenebisteramide (EBS), calcium/zinc stearate and HPDP as flow aid.

### Example 20

Tests of mixtures of poly (hydroxybutyrate) with 6% of product Logosplast 0902 acting as plasticizer, 0.1% of boron nitride acting as nucleant, 0.1% of a mixture (50/50) of thermal stabilizers Irganox E and Hostanox 016 and 0.1% of a mixture (40/40/20) of ethylenebisteramide (EBS), calcium/zinc stearate and HPDP as flow aid.

TABLE 8
Properties of the PHB or PHBV/Additives
polymeric compositions.

| | | Example | Example |
|---|---|---|---|
| PROPERTY | PHB | 19 | 20 |
| Density | 1.2 | 1.2 | 1.2 |
| Fluid index | 16 | 10 | 11 |
| (g/10 min) | | | |
| Tensile Ultimate Strength | 25 | 40 | 38 |
| (MPa) | | | |
| Tensile Elongation at Break | 5 | 12 | 13 |
| (%) | | | |
| Tension Elastic Modulus (Gpa) | 2.1 | 1.8 | 2.2 |
| Notched IZOD Impact Strength | 25 | 40 | 37 |
| (J/m) | | | |
| Color | dark | yellow | Dark |
| | brown | | yellow |

Tests with Flow Aid

According to the results presented in these tests with thermal stabilizers (see page 19), the mixture (40/40/20) of ethylenebisteramide (EBS), calcium/zinc stearate and HPDP mentioned in documents U.S. Pat. No. 6,774,158B2 and U.S. Pat. No. 6,127,512 as a highly efficient stabilizer for the PHB, did not present satisfactory results as a thermal stabilizer. However, tests carried out indicated that this material, jointly with other additives (plasticizer, thermal stabilizer and nucleant), presents characteristics of flow aid, helping in the extrusion and injection processes and contributing to a better surface finishing of the injected piece.

1. Biodegradable polymeric composition, characterized in_that it comprises the poly(hydroxybutyrate) or copolymers thereof, a plasticizer obtained from a renewable source, a nucleant additive; a flow aid additive, and a thermal stabilizer additive.

2. Biodegradable Polymeric composition, as set forth in claim 1, characterized in that it comprises a plasticizer in a proportion (mass/mass) between 2% and 30%, preferably between 2% and 15% and, more preferably, between 5% and 10%; the nucleant additive in a proportion (mass/mass) between 0.01% and 2%, preferably between 0.05% and 1% and, more preferably, between 0.1% and 0.5%; the thermal stabilizer additive in a proportion in the compositions (mass/mass) between 0.01% and 2%, preferably between 0.05% and 1% and, more preferably, between 0.1% and 0.5%; the flow aid additive in a proportion in the compositions (mass/mass) situated between 0.01% and 2%, preferably between 0.05% and 1% and, more preferably, between 0.1% and 0.5%.

3. Biodegradable polymeric composition, as set forth in claim 1, characterized in that the plasticizer is the base of a vegetable oil of natural origin or its ester or epoxy derivative, obtained from soybean, corn, castor oil plant, palm, coconut, peanut, castor oil, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives.

4. Biodegradable polymeric composition, as set forth in claim 3, characterized in that the plasticizer further comprises a fatty composition ranging from: 45-63% of linoleates, 2-4% of linoleinatos, 1-4% of palmitates, 1-3% of palmitoleatos, 12-29% of oleates, 5-12% of stearates, 2-6% of miristates, 20-35% of palmitates, 1-2% of gadoleatos and 0.5-1.6% of behênates.

5. Biodegradable polymeric composition, as set forth in any one of claims 1 or 2, characterized in that the nucleant additive is a chemical compound of the type such as sorbitol, sodium benzoate, saccharine, boron nitride, micronized silica, ammonium chloride or HPN and Millad 3988 nucleants.

6. Biodegradable polymeric composition, as set forth in any one of claims 1 or 2, characterized in that the thermal stabilizer additive is a stabilization package of the Hostanox 101, Hostanox 102, Hostanox 104, Hostanox 105, Hostanox O10. Hostanox 016 and Sandostab QB 55 FF type, or a stabilization package of the Irganox E, Irganox 1425, Irganox 1010. Irganox 1098, Irganox 3790 and Irganox L 115 type.

7. Biodegradable polymeric composition, as set forth in any one of claims 1 or 2, characterized in that the flow aid additive comprises a mixture of about 40% of a metallic soap, about 20% of an organic phosphonate and, about 40% of a fatty amide.

8. Biodegradable polymeric composition, as set forth in claim 7, characterized in that the metallic soap is selected from the group consisting of calcium stearate, zinc stearate, magnesium stearate, aluminum stearate, barium stearate, calcium laurate, zinc laurate, magnesium laurate, barium laurate, aluminum laurate and fatty soaps saturated of other alkaline metals, earth alkalines and also transition metals;

9. Biodegradable polymeric composition, as set forth in claim 7, characterized in that the organic phosphonate is selected from the group consisting of 1-hydroxyethylidene -1,1 disphosphonic acid (HEDP), 1-hydroxypropylidene-1,1 disphosphonic acid (HPDP), 1-hydroxybutylideno-1,1 disphosphonic acid (HBDP) and 1-hydroxycyclohexylidene-1,1 disphosphonic acid (HCEDP).

10. Biodegradable polymeric composition, as set forth in claim 7, characterized in that the fatty amide is selected from the group consisting of oleamide, stearamine, linoleamide, palmitamide, apramide, erucamide, behenamide, ethylenebislauramide, ethylenebissetereamide, ethylenebisoleamide, ethylenebispalmitamide, ethylenebiscapramide, ethylene N palmitamide N stearamide, methylenebisstearamide, hexamethylenebisoleamide, hexamethylenebisstearamide, N,N-dioleiladipamide, N,N dioleilsebacamide, m-xylenebisstearamide, and N,N diestearylisophthalamide.

11. Method for producing a biodegradable polymeric composition, characterized in that it comprises the steps of:
a) mixing to a load of PHB or PHBV in powder, from about 2% to 30% of a plasticizer based on vegetable oils of natural origin and fatty acids of animal and vegetable origin, distilled and hydrogenated;
b) mixing to the biopolymer already containing the plasticizer, from about 0.01% to 2% of a thermal stabilizer additive; a nucleant additive; and a flow aid additive; and
c) extruding the composition obtained in step (b) so as to promote, in the melt state, the incorporation of the additives in the matrix of PHB or PHBV and its subsequent granulation.

12. Method, as set forth in claim 11, characterized in that the plasticizer proportion is from about 2% to 15% and, preferably from about 5% to 10%, the proportion of the other additives ranging between 0.05% and 1% and, preferably, between 0.1 and 0.5%.

13. Method, as set forth in any of claims 11 or 12, characterized in that it utilizes as plasticizer an vegetable oil of natural origin or its ester or epoxy derivative, obtained from soybean, corn, castor oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and possible hydrogenated derivatives thereof.

14. Method, as set forth in claim 13, characterized in that the plasticizer further comprises a fatty composition ranging from: 45-63% of linoleates, 2-4% of linoleinates, 1-4% of palmitates, 1-3% of palmitoleates, 12-29% of oleates, 5-12% of stearates, 2-6% of miristates, 20-35% of palmistate, 1-2% of gadoleates and 0.5-1.6% of behenates.

15. Method, as set forth in any one of claims 11 or 12, characterized in that the nucleant additive is a chemical compound of the type, such as sorbitol, sodium benzoate, saccharine, boron nitride, micronized silica, ammonium chloride or HPN and Millad 3988 nucleants.

16. Method, as set forth in any one of claims 11 or 12, characterized in that the thermal stabilizer additive is a stabilization package of the Hostanox 101, Hostanox 102, Hostanox 104, Hostanox 105, Hostanox O10. Hostanox 016 and Sandostab QB 55 FF type, or a stabilization package of the Irganox E, Irganox 1425, Irganox 1010. Irganox 1098, Irganox 3790 and Irganox L 115 type.

17. Method, as set forth in any claims 11 or 12, characterized in that the flow aid additive comprises a mixture of about 40% of a metallic soap, about 20% of an organic phosphonate and about 40% of a fatty amide.

18. Method, as set forth in claim 17, characterized in that the metallic soap is selected from the group consisting of calcium stearate, zinc stearate, magnesium stearate, aluminum stearate, barium stearate, calcium laurate, zinc laurate, magnesium laurate, barium laurate, aluminum laurate and fatty soaps saturated from other alkaline metals, earth alkalines and also transition metals;

19. Method, as set forth in claim 17, characterized in that the organic phosphonate is selected from the group consisting of 1-hydroxyethylidene-1,1 disphosphonic acid (HEDP), 1-hydroxypropylidene-1,1 disphosphonic acid (HPDP), 1-hydroxybutylideno-1,1 disphosphonic acid (HBDP) and 1-hydroxycyclohexylidene-1,1 disphosphonic acid (HCEDP).

20. Method, as set forth in claim 17, characterized in that the fatty amide is selected from the group consisting of oleamide, estereamina, linoleamide, palmitamide, apramide, erucamide, behenamide, ethylenebislauramide, ethylenebissetereamide, ethylenebisoleamide, ethylenebispalmitamide, ethylenebiscapramide, ethylene N palmitamide N stearamide, methylenebisstearamide, hexamethylenebisoleamide, hexamethylenebisstearamide,N,N-dioleiladipamide, N,N dioleilsebacamide, m-xylenebisstearamide, and N,N diestearylisophthalamide.
